(19) United States
(12) Patent Application Publication
(10) Pub. No.: US 2022/0338231 A1
(43) Pub. Date: Oct. 20, 2022

(54) TERMINAL

(71) Applicant: NTT DOCOMO, INC., Tokyo (JP)

(72) Inventors: Hiroki Harada, Tokyo (JP); Satoshi Nagata, Tokyo (JP); Juan Liu, Beijing (CN); Wenjia Liu, Beijing (CN); Shaozhen Guo, Beijing (CN); Jing Wang, Beijing (CN); Xin Wang, Beijing (CN); Xiaolin Hou, Beijing (CN)

(73) Assignee: NTT DOCOMO, INC., Tokyo (JP)

(21) Appl. No.: 17/633,042

(22) PCT Filed: Aug. 9, 2019
(86) PCT No.: PCT/JP2019/031788

§ 371 Date: Feb. 4, 2022

(51) Int. Cl. H04W 72/12; H04L 27/26

(52) U.S. Cl. CPC H04W 72/1289; H04L 27/2636

(57) ABSTRACT

A terminal is disclosed including a receiving unit that receives a signal that is encoded by using transform precoding; and a controlling unit that assumes that size of transform precoding is determined based on a bandwidth of a downlink.

### TECHNICAL FIELD

The present invention relates to a terminal capable of performing radio communication, particularly, a terminal that supports DFT-S-OFDM.

### BACKGROUND ART

The 3rd Generation Partnership Project (3GPP) specifies Long Term Evolution (LTE), and with the aim of further speeding, specifies LTE-Advanced (hereinbelow, the LTE includes the LTE-Advanced). In the 3GPP, specifications for 5th generation mobile communication system (5G, also called as New Radio (NR) or Next Generation (NG)) are also being considered.

In Release 15 and Release 16 (NR) of the 3GPP, the operation of the bands up to 52.6 GHz is specified. In the specifications after Release 16, operation in a band exceeding 52.6 GHz has been studied (see Non-Patent. Document 1). The target frequency range in Study Item (SI) is 52.6 GHz to 114.25 GHz.

However, when the carrier frequency is very high, for example, when the carrier frequency that exceeds 52.6 GHz, an increase in phase noise and propagation loss becomes a serious problem. Such a carrier frequency is also more sensitive to peak-to-average power ratio (PAPR) and power amplifier nonlinearity.

As one method to address such a problem, Discrete Fourier Transform-Spread (DFT-S-OFDM) can be applied not only (UL) but also for downlink (DL). In Release 15, application of the Cyclic Prefix-Orthogonal Frequency Division Multiplexing (CP-OFDM) for DL is specified.

### PRIOR ART DOCUMENT

### Non-Patent Document

Non-Patent Document 1: 3GPP TR 38.807 V0.1.0, 3rd Generation Partnership Project; Technical Specification Group Radio Access Network; Study on requirements for NR beyond 52.6 GHz (Release 16), 3GPP, March 2019

### SUMMARY OF THE INVENTION

However, when applying DFT-S-OFDM for DL, whether to perform transform precoding (can be referred to as DFT precoding) at a transmitting side, or whether to perform transform decoding (can be referred to as OFT decoding) at a receiving side becomes a problem.

The present invention has been made in view of the above discussion. One object of the present invention is to provide a terminal that can operate appropriately even when DFT-S-OFDM applied for downlink.

According to one aspect of the present disclosure a terminal (UE 200) includes a receiving unit that receives a signal that is encoded by using transform precoding, and a controlling unit that assumes that size of transform preceding is determined based on a bandwidth of a downlink.

### BRIEF DESCRIPTION OF DRAWINGS

FIG. 1 is an overall schematic configuration diagram of a radio communication system 10.

FIG. 2 is a diagram showing a frequency range used in the radio communication system 10.

FIG. 3 is a diagram showing a configuration example of a radio frame, a subframes, and slots used in the radio communication system 10.

FIG. 4 is a diagram showing a functional block configuration of gNB 100 (transmitting unit) according to Configuration Example 1.

FIG. 5 is a diagram showing a functional block configuration of UE 200 (receiving unit) according to Configuration Example 1.

FIG. 6 is a diagram showing a detailed block configuration of the gNB 100 (transmitting unit) according to Configuration Example 1-1.

FIG. 7 is a diagram showing an example of mapping of resources to a plurality of UEs according to Configuration Example 1-1 (DL direction).

FIG. 8 is a diagram showing a detailed block configuration of the gNB 100 (transmitting unit) according to Configuration Example 1-2.

FIG. 9 is a diagram showing an example of mapping of resources to the plurality of the UEs according to Configuration Example 1-2 (DL, direction)

FIG. 10 is a diagram showing a functional block. configuration of the gNB 100 (transmitting unit) according to Configuration Example 2.

FIG. 11 is a diagram showing a functional block configuration of the UE 200 (receiving unit) according to Configuration Example 2.

FIG. 12 is a diagram showing a functional block configuration of the gNB 100 (transmitting unit) according to Configuration Example 2-1.

FIG. 13 is a diagram showing an example of mapping of resources to the plurality of the UEs according to Configuration Example 2-1 (DL direction).

FIG. 14 is a diagram showing an example of mapping of resources to the plurality of the UEs according to Configuration Example 2-2 (DL direction).

FIG. 15 is a diagram showing a functional block configuration of the gNB 100 (transmitting unit) according to Configuration Example 2-3.

FIG. 16 is a diagram showing an example of mapping of resources to the plurality of the UEs within a group according to Configuration Example 2-3 (DL direction).

FIG. 17 is a diagram illustrating an example of hardware configuration of the UE 200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

(1) Overall Schematic Configuration of Radio Communication System

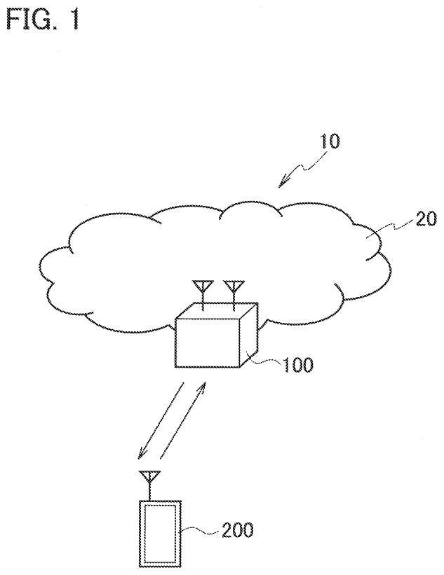

FIG. 1 is an overall schematic configuration diagram of a radio communication system 10 according to the present embodiment. The radio communication system 10 is a radio communication system according to 5G New Radio (NR). The radio communication system 10 includes Next Generation-Radio Access Network 20 (hereinafter, “NG-RAN 20”) and a terminal 200 (hereinafter, “UE 200, “User Equipment”).

The NG-RAN 20 includes a radio base station 100 (hereinafter, “gNB 100”). A concrete configuration of the radio communication system 10, including the number of the gNBs and the UEs, is not limited to the example shown in FIG. 1.

The NG-RAN 20 actually includes a plurality of NG-RAN Nodes, in particular, the gNBs (or ng-eNB). Also, the NG-RAN 20 connected to a core network (5GC, not shown) according to the 5G. The NG-RAN 20 and the 5GC may be simply expressed as “network”.

The gNB 100 is a radio base station according to the 5G. The gNB 100 performs a radio communication with the UE 200 according to the 5G. The gNB 100 and the UE 200 can handle, by controlling a radio signal transmitted from a plurality of antenna elements, Massive MIMO (Multiple-Input Multi-Output) that generates a beam with a higher directivity, carrier aggregation (CA) that bundles a plurality component carriers (CC) to use, dual connectivity (DC) in which communication is performed simultaneously between two NG-RAN Nodes and the UE, and the like.

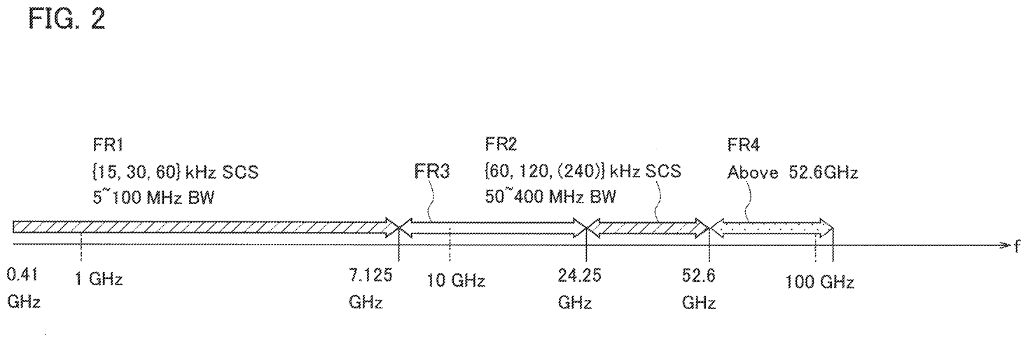

The radio communication system 10 corresponds to a plurality of frequency ranges (FR). FIG. 2 shows the frequency range used in the radio communication system 10.

As shown in FIG. 2, the radio communication system 10 corresponds to FR1 and FR2. The frequency band of each FR is as below.
FR1: 410 MHz to 7.125 GHz
FR2: 24.25 GHz to 52.6 GHz

In FR1, Sub-Carrier Spacing (SCS) of 15 kHz, 30 kHz, or 60 kHz is used, and a bandwidth (SW) of 5 MHz to 100 MHz is used. FR2 is a higher frequency than FR1. Moreover, FR2 uses SCS of 60 kHz or 120 kHz (240 kHz may be included), and uses a bandwidth (BW) of 50 MHz to 400 MHz.

Note that SCS may be interpreted as numerology. The numerology is defined in 3GPP TS38.300 and corresponds to one subcarrier spacing in the frequency domain.

Furthermore, the radio communication system 10 can handle a frequency band that is higher than the frequency band of FR2. Specifically, the radio communication system 10 can handle a frequency band exceeding 52.6 GHz and up to 114.25 GHz. Here, such a high frequency band is referred to as “FR4” for convenience. FR4 belongs to so-called EHF (extremely high frequency, also called millimeter wave). FR4 is a temporary name and may be called by another name.

FR4 may be further classified. For example, FR4 may be divided into a frequency range of 70 GHz or less and a frequency range of 70 GHz or more. Alternatively, FR4 may be divided into more frequency ranges, and may be divided in frequencies other than 70 GHz.

Here, the frequency band between FR2 and FR1 is referred to as “FR3” for convenience. FR3 is a frequency band above 7.125 GHz and below 24.25 GHz.

In the present embodiment, FR3 and FR4 are different from the frequency band including FR1 and FR2, and are called different frequency bands.

Particularly, as described above, in a high frequency band such as FR4, an increase in phase noise between carriers becomes a problem. This may require application of a larger (wider) SCS or a single carrier waveform.

Also, a narrower beam (i.e., a larger number of beams) may be required due to increased propagation loss. In addition, since it is more sensitive to PAPR and power amplifier nonlinearity, a greater (wider) SCS (and/or fewer FFT points), a PAPR reduction mechanism, or a single carrier waveform may be required.

In order to address these issues, in this embodiment, when using a band exceeding 52.6 GHz, Cyclic Prefix-Orthogonal Frequency Division Multiplexing (CP-OFDM)/Discrete Fourier Transform-Spread (DFT-S-OFDM) having a larger Sub-Carrier Spacing (SCS) can be applied.

However, the larger the SCS, the shorter the symbol/Cyclic Prefix (CP) period and the slot period (when the 14 symbol/slot configuration is maintained).

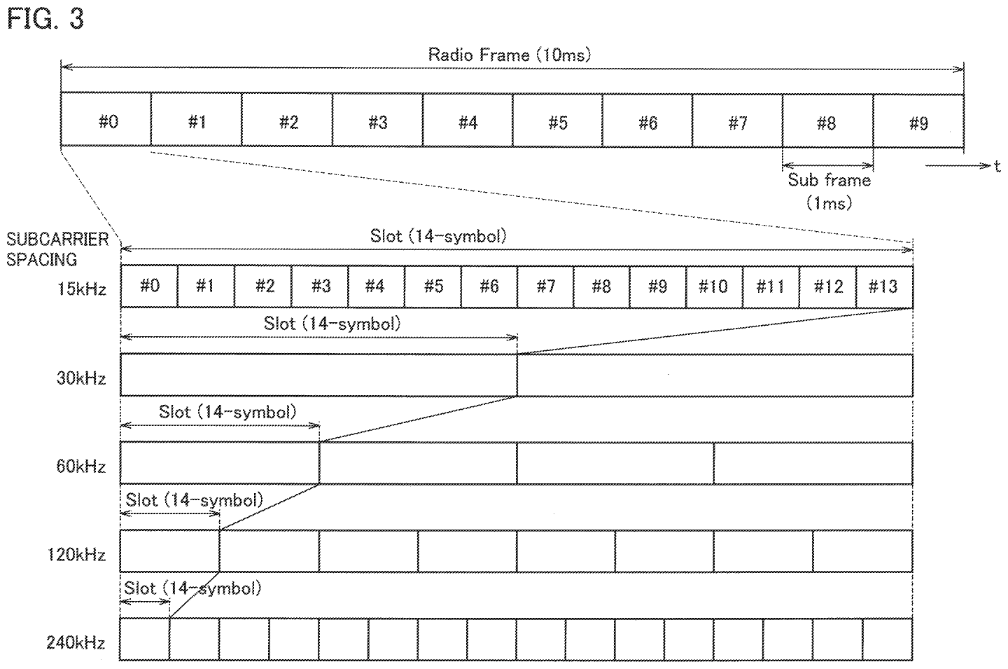

FIG. 3 shows a configuration example of a radio frame, subframes, and slots used in the radio communication system 10. Table 1 shows the relationship between the SCS and the symbol period.

TABLE 1

| | SCS | | | | | | |
|---|---|---|---|---|---|---|---|
| | 15 | 30 | 60 | 120 | 240 | 480 | 960 |
| | kHz | kHz | kHz | kHz | kHz | kHz | kHz |
| Symbol | 66.6 | 33.3 | 16.65 | 8.325 | 4.1625 | 2.08125 | 1.040625 |
| Period | | | | | | | |
| (Unit: μs) | | | | | | | |

As shown in Table 1, when the 14 symbol/slot configuration is maintained, the symbol period (and slot period) becomes shorter as the SCS becomes larger (wider).

In the present embodiment, particularly, when a high frequency band such as FR4 is used, DFT-S-OFDM can be applied for not only the uplink (UL) but also for the downlink (DL). In other words, even if application of CP-OFDM is specified for DL in 3GPP Release 15 (hereinafter appropriately abbreviated as Release 15), in the present embodiment, DFT-S-OFDM can be applied for the UL and the DL.

As explained above, because the high frequency band such as FR4 is more sensitive to PAPR and power amplifier nonlinearity, when applying DFT-S-OFDM for the DL, designing a DFT-S-OFDM waveform that is suitable for the DL becomes necessary.

In the present embodiment, functional block configurations (block diagrams) of a transmitting unit (gNB 100) that is effective in generating such DFT-S-OFDM waveforms suitable for the DL and a receiving unit (UE 200) are provided.

(2) Functional Block Configuration of Radio Communication System

Next, a functional block configuration of the radio communication system 10 will be explained. Specifically, the functional block configuration of the gNB 100 and the UE 200 will be explained. Note that, the following explanation points to an explanation of only the functional blocks relating to a scenario in which DFT-S-OFDM is applied for the DL.

(2.1) Configuration Example 1

In the present configuration example, size of transform preceding (in the following explanation, appropriately referred to as DFT precoding, or simply preceding) is determined based the bandwidth of one terminal (UE). The transform precoding block is added before the resource mapping. While deliberating on how to configure transform precoding and antenna port mapping, support to different multi-antenna precoding must be considered.

(2.1.1) Schematic Configuration

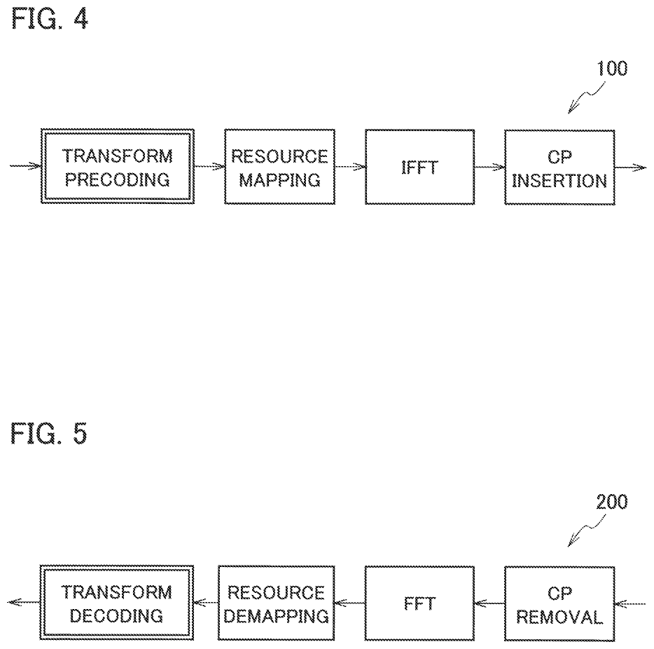

FIG. 4 is a diagram showing a functional block configuration of the gNB 100 (transmitting unit) according to Configuration Example 1. FIG. 5 is a diagram showing a functional block configuration of the UE 200 (receiving unit) according to Configuration Example 1.

As shown in FIG. 4, the transmitting unit includes one block each of transform precoding, resource mapping, Inverse Fast Fourier Transform (IFFT), and CP insertion.

Moreover, the receiving unit includes one block each of CP removal, Fast Fourier Transform (FFT), resource demapping, and transform decoding.

Furthermore, in the present configuration example, the transform decoding block constitutes a receiving unit that receives a signal that is encrypted by transform precoding, and a controlling unit that assumes that the size of transform preceding is determined based on the bandwidth of DL.

In the present configuration example, transform precoding is provided before the resource mapping stage and transform decoding is provided after the resource demapping stage. In other words, transform decoding is performed after the resource demapping stage.

(2.1.2) Detailed Block Configuration

(2.1.2.1) Configuration Example 1-1

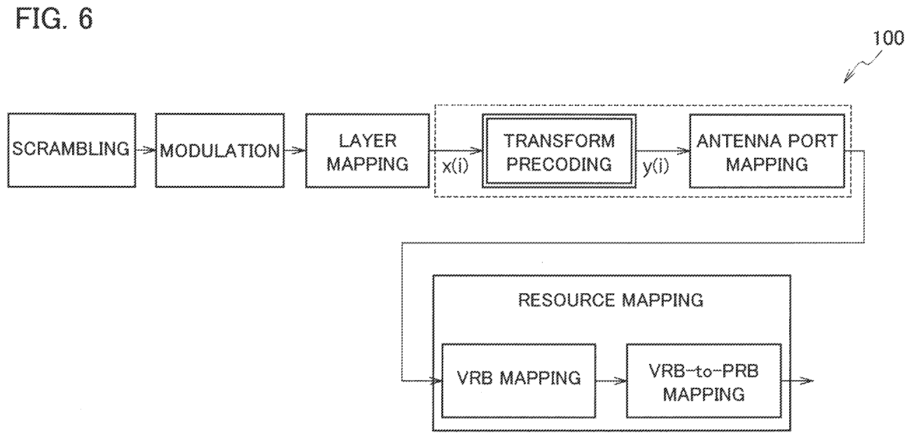

FIG. 6 is a diagram showing a detailed block configuration of the gNB 100 (transmitting unit) according to Configuration Example 1-1. A detailed block configuration of a not-shown UE 200 (receiving unit) according to Configuration Example 1-1 is symmetrical to that of the transmitting unit (that is, transform decoding is provided after the antenna port demapping stage).

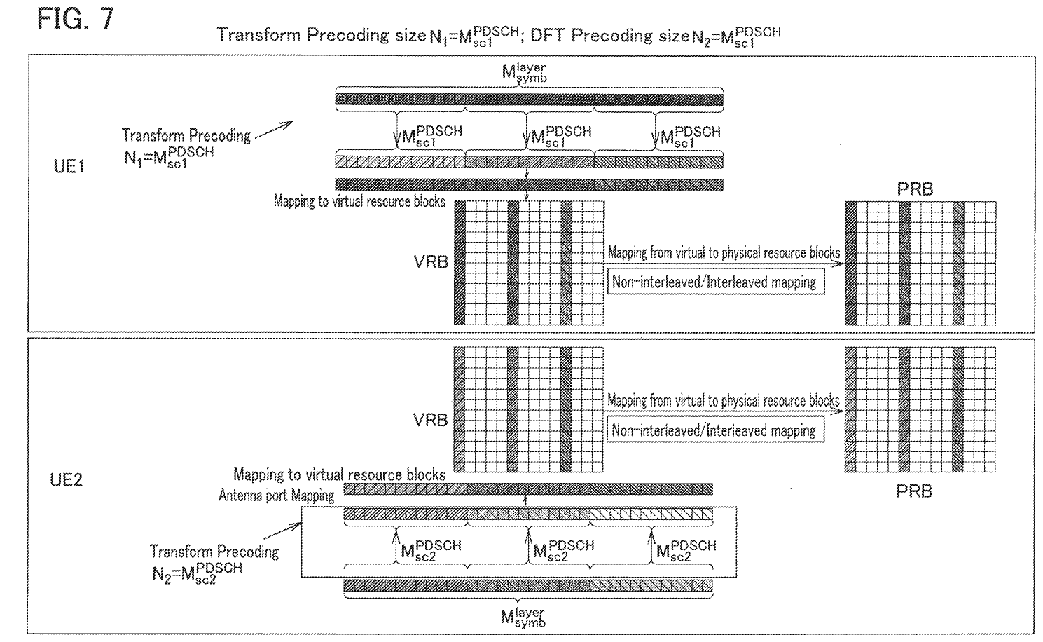

Moreover, FIG. 7 is a diagram showing an example of mapping of resources to the plurality of the UEs according to Configuration Example 1-4 (DL direction).

in the present configuration example, as explained above, the size of transform precoding is determined based on the bandwidth allocated to each UE. Moreover, transform precoding is performed before the resource mapping stage. Specifically, the transform precoding block is added before the antenna port mapping stage.

Furthermore, x (i) represents an output of layer mapping, and the same is expressed in 3GPP TS 38.211 as follows:

x(i)=[x⁽⁰⁾(i) . . . x^{(ν-1)}(i)]^{T}, i=0,1, . . . ,M_{symb}^{layer}−1 [Expression 1]

where ν is number of layers, and

M_{symb}^{layer} [Expression 2]

is the number of modulation symbols per layer. y(i) represents an output after transform precoding, and an input of the antenna port mapping. y(i) is expressed as follows:

y(i)=[y⁽⁰⁾(i) . . . y^{(ν-1)}(i)]^{T}, i=0,1, . . . ,M_{symb}^{layer}−1 [Expression 3]

Furthermore, DMRS for DFT-S-OFDM of UL can be reused. Moreover, other DMRS designs are not particularly eliminated.

When transform precoding is not enabled, the processing can be executed as follows:

y^{(λ)}(i)=x^{(λ)}(i)for each layer, λ=0,1, . . . , ν−1 [Expression 4]

In other words, when transform precoding is not applied, the output of the layer mapping is passed as is to the antenna port mapping.

When transform precoding is enabled, transform precoding is applied according to

$${y}^{( λ )} ( l \cdot {M}_{sc}^{PDSCH} + k ) = \frac{1}{\sqrt{{M}_{sc}^{PDSCH}}} {\sum }_{i = 0}^{{M}_{sc}^{PDSCH} - 1} {x}^{( λ )} ( l \cdot {M}_{sc}^{PDSCH} + i ) {e}^{- j \frac{2 π ik}{{M}_{sc}^{PDSCH}}} \\ k = 0 , … , {M}_{sc}^{PDSCH} - 1 \\ l = 0 , … , {M}_{symb}^{layer} / {M}_{sc}^{PDSCH} - 1 \qquad [ Expression 5 ]$$

resulting in

y^{(λ)}(0), . . . , y^{(λ)}(M_{symb}^{layer}−1) [Expression 6]

a block of complex-valued symbols as shown in the above expression, and the variable

M_{sc}^{PDSCH}=M_{RB}^{PDSCH}·N_{sc}^{RB} [Expression 7]

corresponds to the size of transform preceding, and is based on the number of subcarriers within Physical Downlink Shared Channel (PDSCH) bandwidth allocated to one UE, where

M_{RB}^{PDSCH} [Expression 8]

represents the PDSCH bandwidth in terms of number of resource blocks, and

M_{RB}^{PDSCH}=2^{α}^{₂}·3^{α}^{₃}·5^{α}^{₅} [Expression 9]

fulfills the above, where

α₂, α₃, α₅ [Expression 10]

is a set of non-negative integers, and use of values that are in multiples of 2, 3, 5 is the same as that specified in Release 15.

(2.1.2.2) Configuration Example 1-2

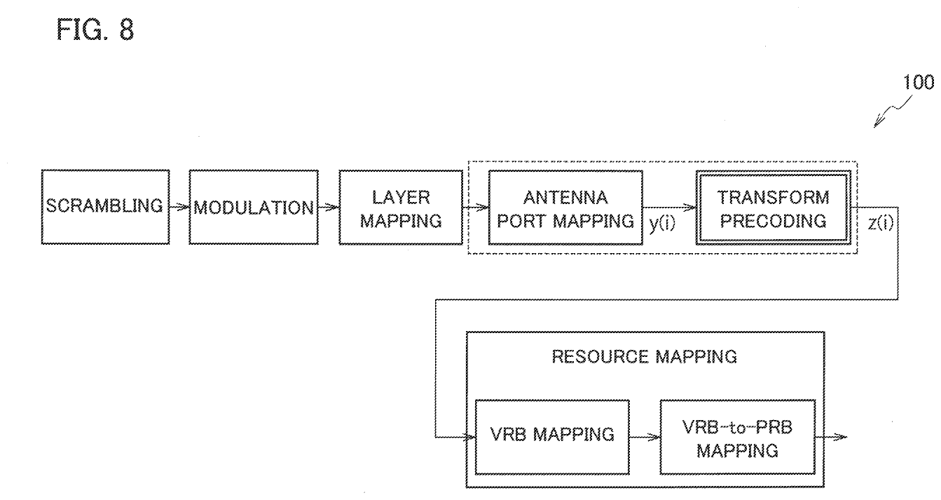

FIG. 8 is a diagram showing a detailed block configuration of the gNB 100 (transmitting unit) according to Configuration Example 1-2. Moreover, a detailed block configuration of a not-shown UE 200 (receiving unit) according to Configuration Example 1-2 is symmetrical to that of the transmitting unit (that is, transform decoding is provided before the antenna port demapping stage)

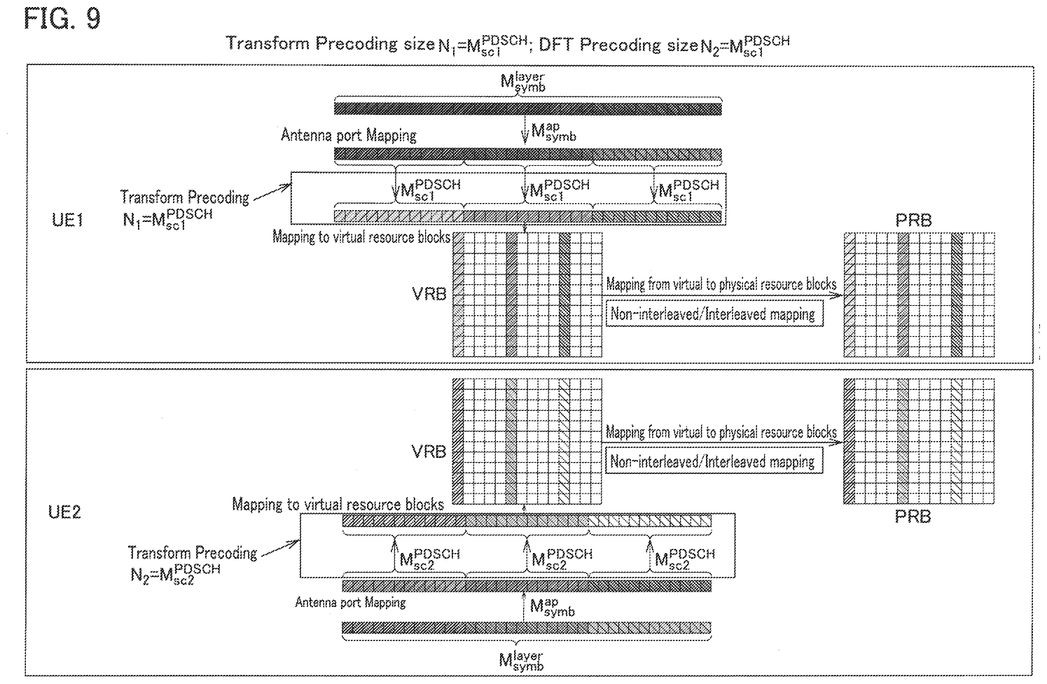

Moreover, FIG. 9 is a diagram showing an example of mapping of resources to the plurality of the UEs according to Configuration Example 1-2 (DL direction).

Processes and elements that are different from that of Configuration Example 1-1 are mainly explained below. As shown in FIG. 8, in the present configuration example, transform precoding is performed after the antenna port mapping. Specifically, the transform precoding block is added after the antenna port mapping stage.

y (i) represents an output of the antenna port mapping, and is expressed as follows:

y(i)=[y^{(p}^{₀}⁾(i) . . . y^{(p}^{_{ν−}}⁾(i)]^{T}, i=0,1, . . . ,M_{symb}^{ap}−1, M_{symb}^{ap}=M_{symb}^{layer} [Expression 11]

Here,

{p₀, . . . , p_{ν-1}} [Expression 12]

is a set of antenna ports, and

M_{symb}^{layer} [Expression 13]

is the number of modulation symbols per layer.

z(i)=[z^{(p}^{₀}⁾(i). . . z^{(p}^{_{ν−}}⁾(i)]^{T}, i=0,1, . . . ,M_{symb}^{ap}−1, M_{symb}^{ap}=M_{symb}^{layer} [Expression 14]

is an output after transform precoding, and an input for the mapping to the virtual resource blocks (VRBs).

When transform precoding is not enabled, the processing can be executed as follows:

z^{(λ)}(i)=y^{(λ)}(i)for each antenna port, λ∈{p₀, . . . , p_{ν-1}} [Expression 15]

In other words, when transform precoding is not applied, the output of the antenna port mapping is passed as is to the resource mapping.

When transform precoding is enabled, transform precoding is applied according to

$${z}^{( λ )} ( l \cdot {M}_{sc}^{PDSCH} + k ) = \frac{1}{\sqrt{{M}_{sc}^{PDSCH}}} {\sum }_{i = 0}^{{M}_{sc}^{PDSCH} - 1} {z}^{( λ )} ( l \cdot {M}_{sc}^{PDSCH} + i ) {e}^{- j \frac{2 π ik}{{M}_{sc}^{PDSCH}}} \qquad [ Expression 16 ]$$

$$k = 0 , … , {M}_{sc}^{PDSCH} - 1$$

$$l = 0 , … , {M}_{symb}^{ap} / {M}_{sc}^{PDSCH} - 1$$

resulting in

z(^{λ)}(0), . . . , z^{(λ)}(M_{symb}^{ap}−1) [Expression 17]

a block of complex-valued symbols as shown in the above expression, and the variable

M_{sc}^{PDSCH}=M_{RB}^{PDSCH}·N_{sc}^{RB} [Expression 18]

corresponds to the size of transform preceding, and based on the number of subcarriers within the Physical Downlink Shared Channel (PDSCH) bandwidth allocated to one UE,

Moreover, Configuration Example 1-2 can be modified as explained below. Specifically, transform precoding can be performed for each transceiver unit (TXRU) and the size of transform precoding can be determined based on the resource bandwidth of each TXRU set for one UE.

More specifically, when the TXRU bandwidth is larger than the UE bandwidth, transform precoding is performed in the bandwidth allocated to the plurality of the UEs, similar to Configuration Example 2-3 explained later. On the other hand, when the TXRU bandwidth is smaller than the UE bandwidth, the UE receives a plurality of the DFT-S-OFDM waveforms.

Moreover, the optional settings explained below can be applied.
(Option 1): A plurality of the TXRUs uses the same frequency resource (Transform precoding size=Resource bandwidth of each TXRU=Resource bandwidth of one UE)
(Option 2): The plurality of the TXRUs uses separate frequency resources (Transform precoding size=Resource bandwidth of each TXRU)

Moreover, the distinguishing points of Configuration Example 1-1 and Configuration Example 1-2 are that, in Configuration Example 1-1, the number of OFT processing becomes the number of transmission layers, and the configuration is simpler In Configuration Example 1-2, because the transmission antenna precoding is performed based on symbols after the layer mapping, higher performance is expected.

(2.2) Configuration Example 2

In the present configuration example, the transform preceding block is added after the resource mapping. Transform precoding is performed after the data of all the UEs is mapped to Physical Resource Block (PRE).

(2.2.1) Schematic Configuration

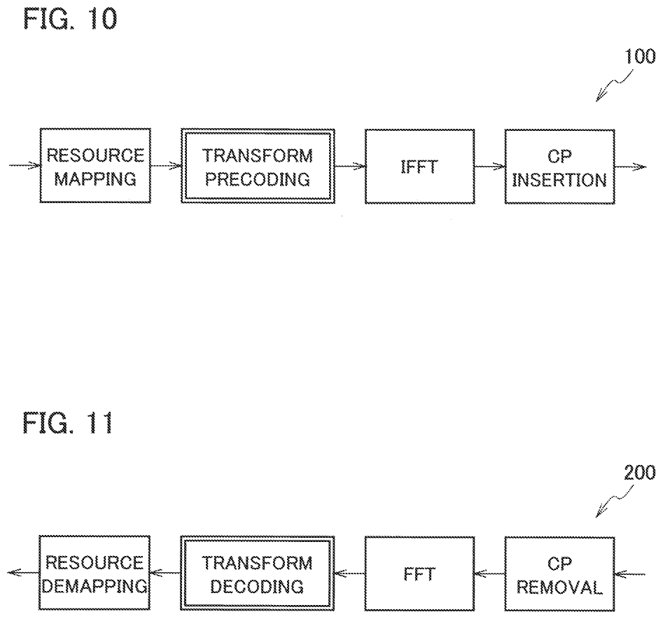

FIG. 10 is a diagram showing a functional block configuration of the gNB 100 (transmitting unit) according to Configuration Example 2. FIG. 11 is a diagram showing a functional block configuration of the UE 200 (receiving unit) according to Configuration Example 2. Processes or elements that are different from that of Configuration Example 1 are mainly explained below.

As shown in FIG. 10, in the transmitting unit according to the present configuration example, the transform precoding block is provided after the resource mapping stage and before the IFFT stage. Moreover, as shown in FIG. 11, in the receiving unit according to the present configuration example, transform decoding is provided after the FFT stage and before the resource demapping stage.

(2.2,2) Detailed Block Configuration

(2.2.2.1) Configuration Example 2-1

In the present configuration example, the size of transform preceding is determined based on the bandwidth of the DL system (channel bandwidth, the carrier component (CC) bandwidth).

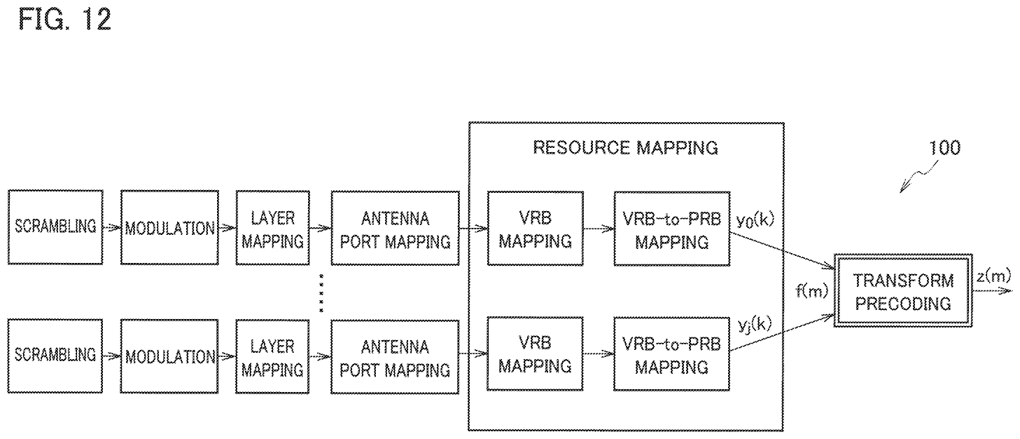

FIG. 12 is a diagram showing a functional block configuration of the gNB 100 (transmitting unit; according to Configuration Example 2-1. A detailed block configuration of a not-shown UE 200 (receiving unit) according to Configuration Example 2-1 is symmetrical to that of the transmitting unit (that is, transform decoding is provided before the resource demapping stage). In the present configuration example, the transform decoding block constitutes a controlling unit that assumes that the size of transform precoding is determined based on the bandwidth of the downlink.

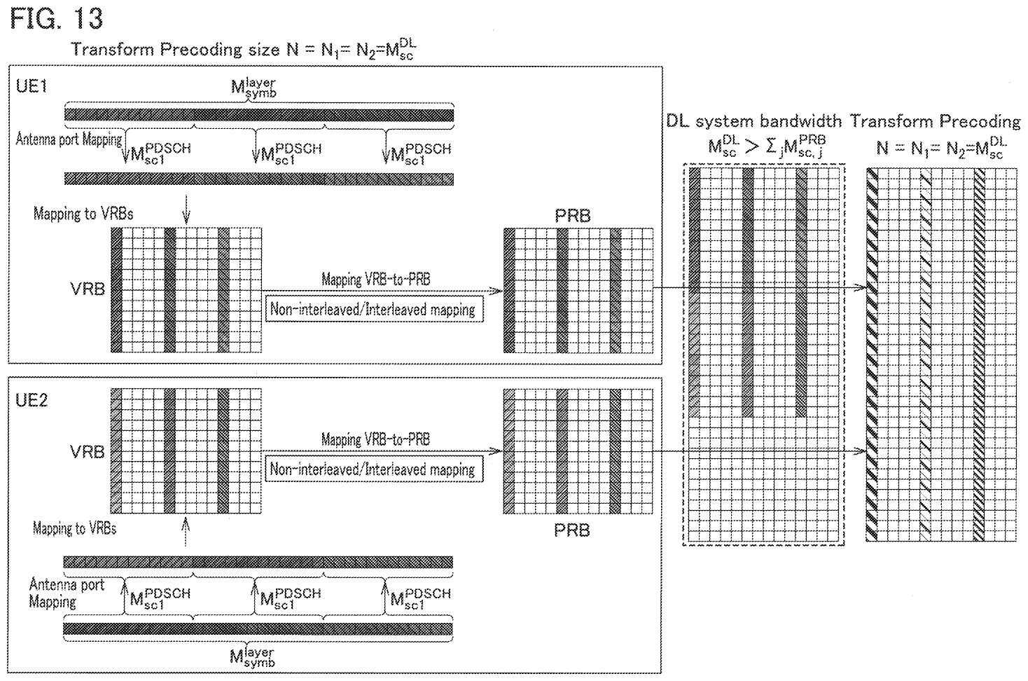

Moreover, FIG. 13 is a diagram showing an example of mapping of resources to the plurality of the UEs according to Configuration Example 2-1 (DL direction).

y_{l,j}^{(p)}(0), y_{l,j}^{(p)}(k), . . . , y_{l,j}^{(p)} (M_{sc,j}^{PRB}−1), k=0,1, . . . ,M_{sc,j}^{PRB}−1 [Expression 19]

is a block of complex-valued symbols, and is an output of time domain index 1 VRB-to-PRB for UE j, where

M_{sc,j}^{PRB} [Expression 20]

is a subcarrier number of the PRB for UE j. Input to transform precoding

fₗ^{(p)}(0), fₗ^{(p)}(m), . . . , fₗ^{(p)} (M_{sc}^{DL}−1) [Expression 21]

corresponds to the PDSCH transmission, and

m=0, 1, . . . , M_{sc}^{DL}−1, M_{sc}^{DL} [Expression 22]

is a DL system bandwidth.

ΣⱼM_{sc,j}^{PRB}<M_{sc}^{DL} zₗ^{(p)}(0), zₗ^{(p)}(m), . . . , zₗ^{(p)} (M_{sc}^{DL}−1), m=0, 1, . . . , M_{sc}^{DL}−1 [Expression 23]

is an output of transform precoding.

When transform precoding is not enabled, the processing can be executed as follows:

zₗ^{(p)}(m)=fₗ^{(p)}(m)for each antenna port [Expression 24]

In other words, when transform precoding is not applied, the output of VRB to PRE mapping is passed as is to the IFFT mapping

When transform preceding is enabled, transform precoding is applied according to

$${z}_{l}^{p} ( m ) = \frac{1}{\sqrt{{M}_{s c}^{D L} - 1}} {\sum }_{i = 0}^{{M}_{s c}^{D L} - 1} {f}_{l}^{p} ( m ) {e}^{- j \frac{2 π ik}{{M}_{s c}^{D L}}} \\ m = 0 , … , {M}_{s c}^{D L} - 1 \qquad [ Expression 25 ]$$

resulting in

z_{l,j}^{(p)}(0), z_{l,j}^{(p)}(k), . . . , z_{l,j}^{(p)} (M_{sc,j}^{PRB}−1), k=0,1, . . . ,M_{sc,j}^{PRB}−1 [Expression 26]

a block of complex-valued symbols as shown in the above expression, and the variable

M_{sc}^{DL}=M_{RB}^{DL}·N_{sc}^{RB} [Expression 27]

corresponds to the size of transform precoding, and is based on the number of subcarriers within the DL system bandwidth, where

M_{RB}^{DL} [Expression 28]

is a number of RBs within the DL system bandwidth, and

M_{RB}^{DL}=2^{α}^{₂}·3^{α}^{₃}·5^{α}^{₅} [Expression 29]

fulfills the above.

Furthermore, which part of the OFT input IDFT output) is the data allocated to the UE can be recognized by using frequency resource allocation information (in Downlink Control Information (DCI)). Based on the settings of the DL system bandwidth, which part of the FFT output the IDFT is to be applied to, is determined. Accordingly, the size of transform precoding is based on the number of subcarriers within the DI, system bandwidth.

(2.2.2.2) Configuration Example 2-2

Block configuration of a transmitting unit and a receiving unit according to the present configuration example is the same as that explained in Configuration Example 2-1. In the present configuration example, the size of transform precoding is determined based on total allocated PDSCH bandwidth in all UEs.

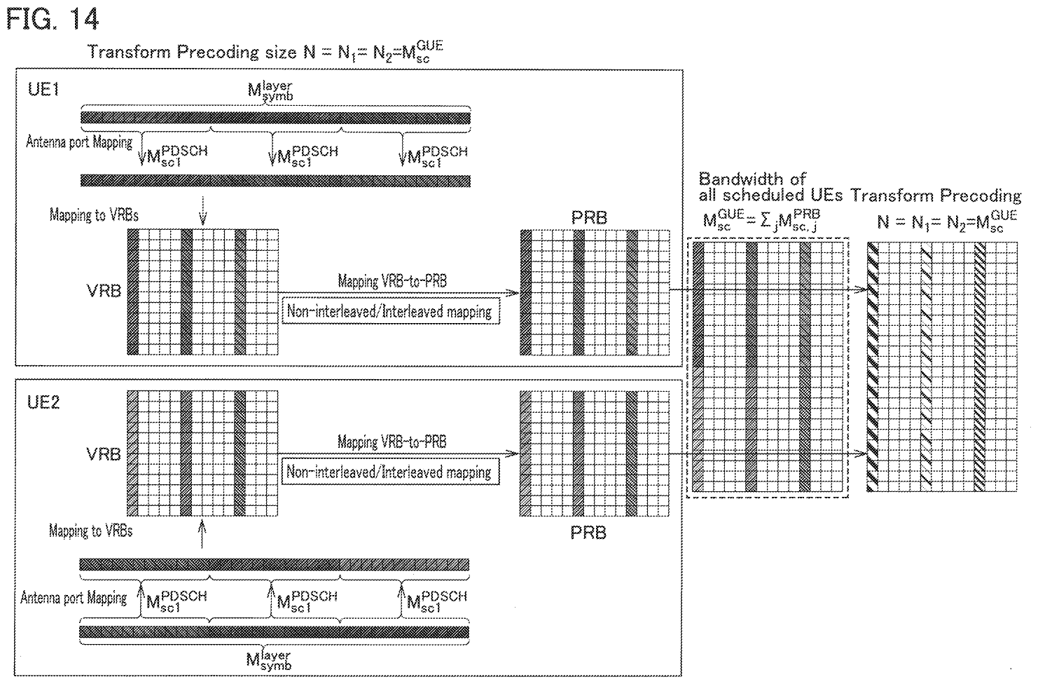

In FIG. 14, an example of mapping of resources to the plurality of the UEs according to Configuration Example 2-2 (DL direction) is shown.

y_{l,j}^{(p)}(0), y_{l,j}^{(p)}(k), . . . , y_{l,j}^{(p)} (M_{sc,j}^{PRB}−1), k=0,1, . . . ,M_{sc,j}^{PRB}−1 [Expression 30]

is a block of complex-valued symbols, and is similar to that explained in Configuration Example 2-1. Input to transform precoding

∫ₗ^{(p)}(0), ∫ₗ^{(p)}(m), . . . , ∫ₗ^{(p)} (M_{sc}^{GUE}−1) [Expression 31]

corresponds to the PDSCH transmission, and

$$m = 0 , 1 , … , {M}_{sc}^{GUE} - 1 , {M}_{sc}^{GUR} = {\sum }_{j} {M}_{sc , j}^{PRB} \qquad [ Expression 32 ]$$

is the bandwidth relating to scheduled subcarriers of all UEs.

z_{l,j}^{(p)}(0), z_{l,j}^{(p)}(m), . . . , z_{l,j}^{(p)} (M_{sc}^{GUE}−1), m=0,1, . . . ,M_{sc}^{GUE}−1 [Expression 33]

is the output of transform precoding.

When transform precoding is enabled, transform precoding is applied according to

$${z}_{l}^{p} ( m ) = \frac{1}{\sqrt{{M}_{s c}^{GUE} - 1}} {\sum }_{i = 0}^{{M}_{s c}^{GUE} - 1} {f}_{l}^{p} ( m ) {e}^{- j \frac{2 π ik}{{M}_{s c}^{GUE}}} \\ m = 0 , … , {M}_{s c}^{GUE} - 1 \qquad [ Expression 34 ]$$

resulting in

zₗ^{(p)}(0), zₗ^{(p)}(m), . . . , zₗ^{(p)} (M_{sc}^{GUE}−1) [Expression 35]

a block of complex-valued symbols as shown in the above expression, and the variable

M_{sc}^{GUE}=M_{RB}^{GUE}·N_{sc}^{RB} [Expression 36]

corresponds to the size of transform precoding, and is based on the number of subcarriers within the PDSCH bandwidth allocated to all UEs, where

M_{RB}^{GUE} [Expression 37]

represents the number of RBs within the PDSCH bandwidth allocated to all UEs, and

M_{RB}^{GUE}=2^{α}^{₂}·3^{α}^{₃}·5^{α}^{₅} [Expression 38]

fulfills the above.

Furthermore, which part of the DFT input (IDFT output) is the data allocated to the UE can be recognized by using the frequency resource allocation information (in Downlink Control Information (DCI)). Similar to the size of transform precoding in DCI, which part of the FFT output the IDFT is to be applied to, is notified separately.

(2.2.2.3) Configuration Example 2-3

In the present configuration example, the size of transform precoding is determined based on the PDSCH bandwidth allocated to all UEs within a group.

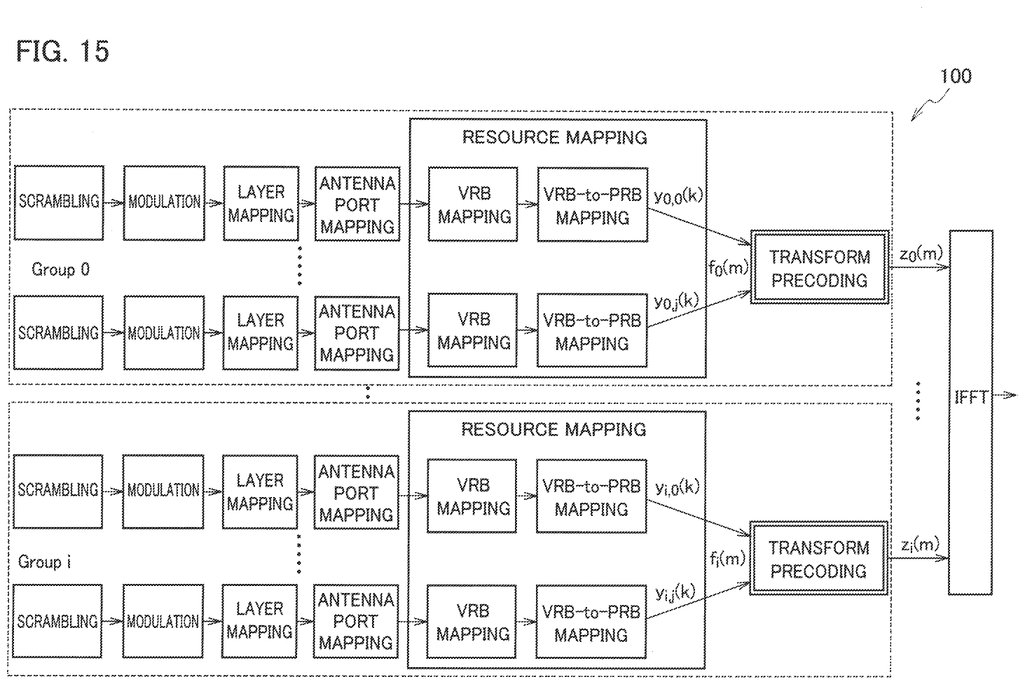

FIG. 15 is a diagram showing a functional block configuration of the gNB 100 (transmitting unit) according to Configuration Example 2-3. A detailed block configuration of a not-shown UE 200 (receiving unit) according to Configuration Example 2-3 is symmetrical to that of the transmitting unit (that is, transform decoding is provided before the resource demapping stage).

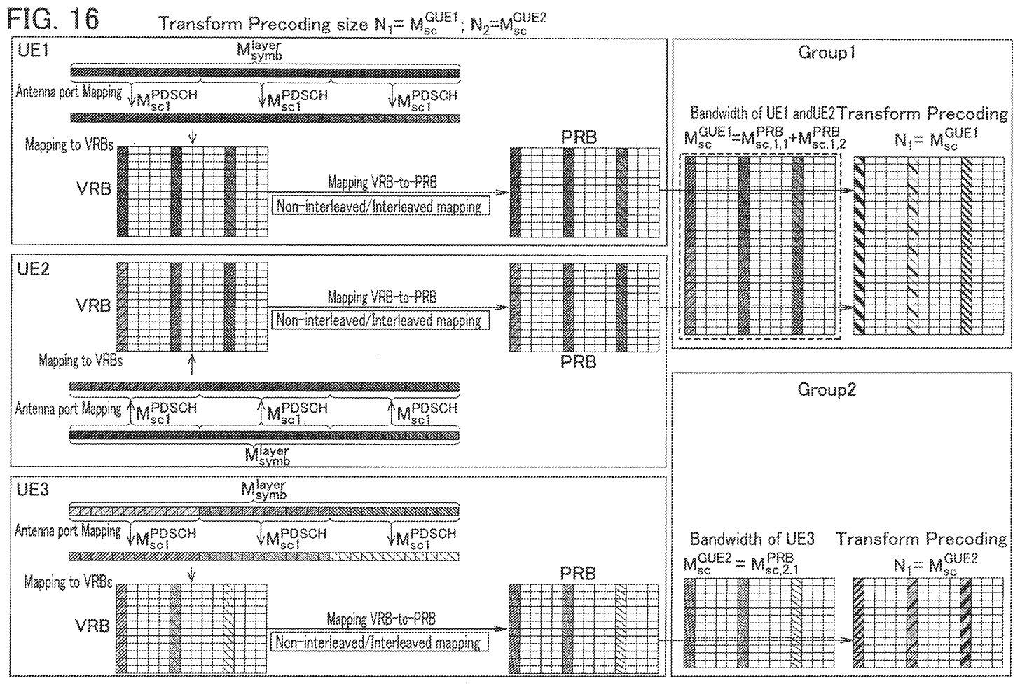

Moreover, in FIG. 16, an example of mapping of resources to the plurality of the UEs within a group according to Configuration Example 2-3 (DL direction) is shown.

jy_{l,i,j}^{(p)}(0), y_{l,i,j}^{(p)}(k), . . . , y_{l,i,j}^{(p)} (M_{sc,t,j}^{PRB}−1), k=0,1, . . . ,M_{sc,t,j}^{PRB}−1 [Expression 39]

is a block of value symbols, and is an output of time domain index 1 VRB-to-PRB for UE j within the group, where

M_{sc,i,j}^{PRB} [Expression 40]

is a subcarrier number of PRE for UE j within the group. Input to transform precoding

f_{l,i}^{(p)}(0), f_{l,i}^{(p)}(m), . . . f_{l,i}^{(p)}(M_{sc}^{GUEi}−1) [Expression 41]

corresponds to the PDSCH transmission, and

$$m = 0 , 1 , … , {M}_{sc}^{GUEi} - 1 , {M}_{sc}^{GURi} = {\sum }_{j} {M}_{sc , i , j}^{PRB} \qquad [ Expression 32 ]$$

is the bandwidth relating to scheduled subcarriers of all UEs within the group.

z_{l,i}^{(p)}(0), z_{l,i}^{(p)}(m), . . . z_{l,i}^{(p)}(M_{sc}^{GUEi}−1) [Expression 43]

is an output of transform precoding of group i.

When transform precoding is not enabled, the processing can be executed as follows:

z_{l,i}^{(p)}(m)=f_{l,i}^{(p)}(m) [Expression 44]

In other words, when transform precoding is not applied, the output of the VRB to PRB mapping (resource mapping) is passed as is to the IFFT.

When transform precoding is enabled, transform precoding is applied according to

$${z}_{l , i}^{p} ( m ) = \frac{1}{\sqrt{{M}_{s c}^{GUEi} - 1}} {\sum }_{i = 0}^{{M}_{s c}^{GUEi} - 1} {f}_{l , i}^{p} ( m ) {e}^{- j \frac{2 π ik}{{M}_{s c}^{GUEi} - 1}} \\ m = 0 , … , {M}_{s c}^{GUEi} - 1 \qquad [ Expression 45 ]$$

z_{l,i}^{(p)}(0), z_{l,i}^{(p)}(m), . . . z_{l,i}^{(p)}(M_{sc}^{GUEi}−1) [Expression 46]

a block of complex-valued symbols as shown in the above expression, and the variable

M_{sc}^{GUEi}=M_{RB}^{GUEi}·N_{sc}^{RB} [Expression 47]

corresponds to the size of transform precoding, and is based on the number of subcarriers within the PDSCH bandwidth allocated to all UEs included in the group i, where

M_{RB}^{GUEi} [Expression 48]

is a number of RBs within the PDSCH bandwidth allocated to all UEs included in group i, and

M_{RB}^{GUEi}=2^{α}^{₂}·3^{α}^{₃}·5^{α}^{₅} [Expression 49]

fulfills the above.

Furthermore, which part of the DFT input (IDFT output) is the data allocated to the UE can be recognized by using the frequency resource allocation information (in Downlink Control Information (DCI)). Similar to the size of transform precoding in DCI, which part of the FFT output the IDFT is to be applied to, is notified separately.

(2.3) Evaluation of Configuration Examples

Configuration Example 1 explained above can be evaluated based on the point that the block configuration of the transmitting unit that is similar to that explained in Release 15 and Release 16 can be used. Moreover, because the size of transform precoding (DFT precoding) is small, complexity of the transmission unit and the receiving unit is not high.

In Configuration Example 2-1, because transform precoding is based on the plurality of the UEs, such configuration can demonstrate an excellent PAPR compared to that of Configuration Example 1.

Even in Configuration Examples 2-2 and 2-3, because transform precoding is based on the plurality of the UEs, such configuration can demonstrate an excellent PAPR compared to that of Configuration Example 1. Moreover, the size of transform precoding can be determined flexibly, and an appropriate value can be used in accordance with the functionality and/or complexity of the UE.

(3) Application of DFT-S-OFDM to PDSCH

Application of DFT-S-OFDM to PDSCH can be realized based on options explained below.
(Option 1): Always apply transform precoding to the PDSCH in a specific frequency band, or always apply transform precoding to PDSCH of a specific purpose.
(Option 2): Notify whether to apply transform precoding via Master Information Block (MIB), System Information Block (SIB), or Signaling of an upper layer (for example, Radio Resource Control (RRC)).

In the case of Option 2, furthermore, operation explained below can be applied.
(2-1): In the RRC signaling, a separate transform precoding is configured for the PDSCH that is scheduled via the DCI that is specific to UE, and Semi-Persistent Scheduling (SPS) PDSCH.
(2-2): Transform precoding is configured for both PDSCHs.

Accordingly, the transform precoding block can determine whether to apply transform precoding to PDSCH (downlink data channel) based on a frequency range used by a terminal (UE) or signaling transmitted from a network.

(4) Notifying Size of Transform Precoding

Alternatively, the size of transform precoding can be notified to the terminal (UE) by using methods explained below.
(Option 1): Transform precoding size is substantially notified by determining the size implicitly.

For example, a transform precoding size that is the same as the size of the frequency resources allocated to the UE is assumed (in the case of Configuration Example 1).
(Option 2): The transform precoding size is notified explicitly.

For example, the size can be notified by using a new field or an unused field of the DCI.

(5) Behavior of Terminal when DFT-S-OFDM is Applied to PDSCH

When DFT-S-OFDM is applied to PDSCH, the terminal (UE) can behave as explained below. For example, when receiving PDSCH that is scheduled via the DCI that is Cyclic Redundancy Checksum (CRC) scrambled by using a specific Radio Network Temporary Identifier (RNTI), specifically, SI-RNTI, RA-RNTI, P-RNTI, or TC-RNTI, the terminal can recognize whether transform precoding is applied in accordance with the settings of an upper layer, for example, MIB or SIB (in the case of RRC IDLE/INACTIVE/CONNECTED UE).

Alternatively, when receiving PDSCH that is scheduled via the DCI that is CRC scrambled by using other RNTI (C-RNTI, NCS-C-RNTI, or CS-RNTI) the terminal can recognize whether transform precoding is applied in accordance with the settings of an upper layer (MIB/SIB) when DCI format is 1_0.

On the other hand, when the DCI format is any format other than 1_0, the terminal can determine whether to refer to transformPrecoder of pdsch-Config (3GPP TS38.331), or whether transform precoding is applied in accordance with the settings of an upper layer (MIB/SIB).

Alternatively, in the case of SPS-PDSCH, the terminal can determine whether to refer to transformPrecoder of sps-config, or whether transform precoding is applied in accordance with the settings of an upper layer (MIB/SIB).

Accordingly, when receiving PDSCH (downlink data channel) scheduled by DCI that is scrambled by using RNTI (identification information) of the terminal, the terminal can determine whether transform precoding is applied to PDSCH based on signaling of an upper layer and the like.

(4) Effects and Advantages

According to embodiments explained above, the following effects can be achieved. Specifically, when DFT-S-OFDM is applied for DL, the transform precoding block in the transmitting unit (gNB 100), the receiving unit (UE 200), and the transform decoding block can be provided at an appropriate location (see FIGS. 4, 5, 10, 11, and the like).

Accordingly, because transform precoding and transform decoding processing can be executed reliably particularly even when DFT-S-OFDM is applied for the DL using high frequency band such as FR4 and the like, the gNB 100 and the UE 200 can operate appropriately.

Moreover, in the present embodiment, the transform precoding size can be determined for each terminal (UE) based on the DL system bandwidth or the bandwidth of the UE that is scheduled within a groups Accordingly, an appropriate transform precoding that is in accordance with function and/or complexity of the UE can be used.

(5) Other Embodiments

Although the contents of the present invention have been described by way of the embodiments, it is obvious to those skilled in the art that the present invention is not limited to what is written here and that various modifications and improvements thereof are possible.

Although the contents of the present invention have been described by way of the embodiments, it is obvious to those skilled in the art that the present invention is not limited to what is written here and that various modifications and improvements thereof are possible.

For example, in the embodiments explained above, a high frequency band such as FR4, that is, a frequency band that exceeds 52.6 GHz is cited as an example; however, in any of the configuration examples explained above, other frequency range such as FR3 can be applied.

Furthermore, as explained above, FR4 can be categorized as a frequency range that is equivalent or below 70 GHz and a frequency range that is equivalent or above 70 GHz, and the relation between the configuration examples and the frequency ranges can be changed appropriately by applying any of the configuration examples to the frequency range that is equivalent or above 70 GHz, applying a configuration example other than that applied to the frequency range that is equivalent or above 70 GHz to a frequency range that is equivalent or below 70 GHz, and the like.

Moreover, in the embodiments explained above, applying DFT-S-OFDM for the DL is cited as an example; however, even when DFT-S-OFDM is applied for UL, a transmitting unit (UE 200) and a receiving unit (gNB 100) that include block configuration shown in FIGS. 4, 5, 10, and 11 can be used.

The block diagram used for explaining the embodiments (FIGS. 4, 5, 10, and 11) shows blocks of functional unit. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that causes transmitting may be called a transmitting unit or a transmitter. For any of the above, as explained above, the realization method is not particularly limited to any one method.

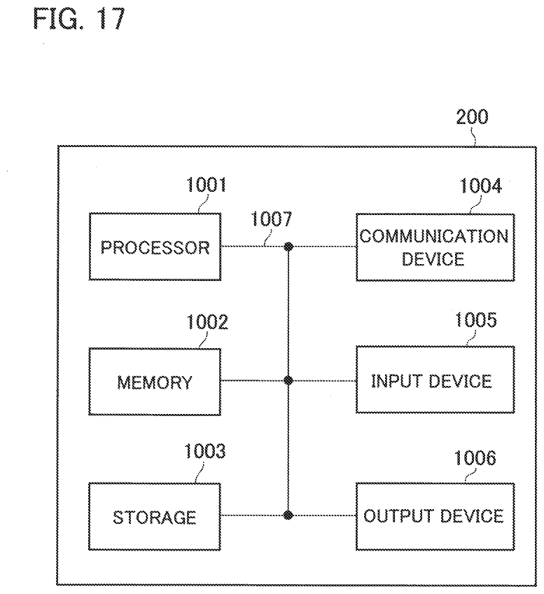

Furthermore, the UE 200 explained above can function as a computer that performs the processing of the radio communication method of the present disclosure. FIG. 17 is a diagram showing an example of a hardware configuration of the UE 200. As shown in FIG. 17, the UE 200 can be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

The functional blocks of the UE 200 (see FIG. 4) can be realized by any of hardware elements of the computer device or a desired combination of the hardware elements.

Moreover, the processor 1001 performs computing by loading a predetermined software (computer program) on hardware such as the processor 1001 and the memory 1002, and realizes various functions of the UE 200 by controlling communication via the communication device 1004, and controlling reading and/or writing of data on the memory 1002 and the storage 1003.

The processor 1001, for example, operates an operating system to control the entire computer. The processor 1001 can be configured with a central processing unit (CPU) including an interface with a peripheral device, a control device, a computing device, a register, and the like.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 can be called register, cache, main memory (main memory), and the like. The memory 1002 can store therein a computer program (computer program codes), software modules, and the like that can execute the method according to the embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark.) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information there among. The bus 1007 can be constituted by a single bus or can be constituted by separate buses between the devices.

Further, the device is configured to include hardware such as a microprocessor, a digital signal processor (Digital Signal Processor: DSP), Application Specific Integrated. Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Notification of information is not limited to that explained in the above aspect/embodiment, and may be performed by using a different method. For example, the notification of information may be performed by physical layer signaling (for example, Downlink Control Information (DCI), Uplink Control Information (UCI), upper layer signaling (for example, RRC signaling, Medium Access Control (MAC) signaling, notification information (Master Information Block (MIB) System Information Block (SIB)), other signals, or a combination of these. The RRC signaling may be called RRC message, for example, or can be RRC Connection Setup message, RRC Connection Reconfiguration message, or the like.

Each of the above aspects/embodiments can be applied to at least one of Long Term Evolution (LTE) LTE-Advanced (LTE-A), SUPER 3G, IMT-Advanced, 4th generation mobile communication system (4G), 5th generation mobile communication system (5G), Future Radio Access (FRA), New Radio (NR) W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB) Bluetooth (Registered Trademark), a system using any other appropriate system, and a next-generation system that is expanded based on these. Further, a plurality of systems may be combined (for example, a combination of at least one of the LTE and the LTE-A with the 5G).

As long as there is no inconsistency, the order of processing procedures, sequences, flowcharts, and the like of each of the above aspects/embodiments in the present disclosure may be exchanged. For example, the various steps and the sequence of the steps of the methods explained above are exemplary and are not limited to the specific order mentioned above.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used

Information, signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value)

Each aspect/embodiment described in the present disclosure may be used separately or in combination, or may be switched in accordance with the execution. In addition, notification of predetermined information (for example, notification of “being X”)is not limited to being performed explicitly, it may be performed implicitly (for example without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings For example, at least one of a channel and a symbol may be a signal(signaling)). Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

On the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), a robot (manned type or unmanned type) At least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration that allows a communication between a base station and a mobile station to be replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, terms an uplink channel, a downlink channel, or the like may be read as a side channel.

Likewise, a mobile station in the present disclosure may be read as a base station. In this case, the base station may have the function of the mobile station. A radio frame may be composed of one or more frames in the time domain. Each frame or frames in the time domain may be referred to as a subframe.

A subframe may be further configured by one or more sluts in the time domain. The subframe may have a fixed time length (e.g., 1 ms) that does not depend on the numerology.

Numerology may be a communication parameter applied to at least one of transmission and reception of a certain signal or channel. The numerology can include one among, for example, subcarrier spacing (SubCarrier Spacing: SCS) bandwidth, symbol length, cyclic prefix length, transmission time interval (TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in a time unit larger than a minislot may be referred to as PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one between a subframe and TTI may be a subframe (1 ms) in existing LTE, or may be shorter than 1 ms (for example, 1 to 13 symbols), or a period longer than 1 ms. Note that, a unit representing TTI may be called a slot, a minislot, or the like instead of a subframe.

Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. Further, the number of slots (the number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the numerology. The number of subcarriers included in the RB may be determined based on the numerology.

Also, the time domain of RB may include one or a plurality of symbols, and may have a length of 1 slot, 1 minislot, subframe, or 1 TTI, Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (Bandwidth Part: BWP) (which may be called a partial bandwidth, etc.) may represent a subset of contiguous common resource blocks (RBs) for a certain numerology in a certain carrier. Here, a common RB may be specified by RB index based on the common reference point of the carrier. PRB may be defined in BWP and numbered within that BWP.

BWP may include UL BWP (UL BWP) and DL BWP (DL BWP) One or a plurality of BWPs may be set in one carrier for the UE.

At least one of the configured BWPs may be active, and the UE may not expect to send and receive certain signals/channels outside the active BWP. Note that “cell”, “carrier”, and the like in this disclosure may be read as “BWP”.

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

The “means” in the configuration of each apparatus may be replaced with “unit”, “circuit”, “device”, and the like.

Any reference to an element using a designation such as “first”, “second” and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining” and “determining” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving. (for example, receiving information) transmitting (for example, transmitting information), input (input) output (output), and access (accessing) (e.g., accessing data in a memory). In addition, “judgement” and “decision” can include judging or deciding by resolving, selecting, choosing, establishing, and comparing. In other words, “judgement” and “decision” may include considering some operation as “judged” and “decided”. Moreover, “judgment (decision)” may be read as “assuming”, “expecting”, “considering”, and the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is riot limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 Radio communication system

20 NG-RAN

100 gNB

200 UE

1001 Processor

1002 Memory

1003 Storage

1004 Communication device

1005 Input device

1006 Output device

1007 Bus

1. A terminal comprising:
a receiving unit that receives a signal that is encoded by using transform precoding; and
a controlling unit that assumes that size of transform precoding is determined based on a bandwidth of a downlink.

2. The terminal as claimed in claim 1, wherein the receiving unit performs transform decoding after a resource demapping stage.

3. The terminal as claimed in claim 1, wherein the receiving unit performs transform decoding before a resource demapping stage.

4. The terminal as claimed in claim 1, wherein the controlling unit determines whether transform precoding is applied for a downlink data channel based on a frequency range used by the terminal or signaling transmitted from a network.

5. The terminal as claimed in claim 4, wherein, when receiving the downlink data channel that is scheduled via downlink control information that is scrambled by using identification information of the terminal, the controlling unit determines whether transform precoding is applied for the downlink data channel based on the signaling.

6. The terminal as claimed in claim 2, wherein the controlling unit determines whether transform precoding is applied for a downlink data channel based on a frequency range used by the terminal or signaling transmitted from a network.

7. The terminal as claimed in claim 3, wherein the controlling unit determines whether transform precoding is applied for a downlink data channel based on a frequency range used by the terminal or signaling transmitted from a network.
